(19) United States
(12) Patent Application Publication
(10) Pub. No.: US 2009/0316738 A1
(43) Pub. Date: Dec. 24, 2009

(54) DEVICE FOR AMPLITUDE AND PHASE PROGRAMMING OF LONG LIGHT PULSES WITH NARROW SPECTRAL BAND STARTING FROM A MODULATOR OF SHORT LIGHT PULSES WITH WIDE SPECTRAL BAND

(75) Inventors: Pierre Tournois, Cagnes S/Mer (FR); Nicolas Forget, Orsay (FR)

Correspondence Address: BROWDY AND NEIMARK, P.L.L.C.;624 NINTH STREET, NW, SUITE 300, WASHINGTON, DC, 20001-5303, US

(73) Assignee: Fastlite, Paris (FR)

(21) Appl. No.: 12/298,031

(22) PCT Filed: Apr. 12, 2007
(86) PCT No.: PCT/FR2007/000621

§ 371 Date: May 19, 2009

(30) Foreign Application Priority Data
Apr. 21, 2006 (FR) 06 03526

(51) Int. Cl. H01S 3/10

(52) U.S. Cl. 372/21; 372/28

(57) ABSTRACT

Device for adaptation of a programmable generator of ultra short wide spectral band light pulses, to long narrow spectral band light pulses comprising a laser source (1) of ultra-short wide spectral band pulses, a device (2) for dispersion of ultra-short pulses output from said laser source (1), a first non-linear optical mixer (4) to mix long modulated pulses output from said dispersion device (2) with long quasi-monochromatic signals output from a pure frequency pump laser (3), a generator (5) of wide spectral band light pulses placed on a first channel (V1), a second non-linear optical mixer (6) to mix the channel output from said generator (5) and a second channel (V2) emerging from said first non-linear optical mixer (4).

The present invention concerns a device for amplitude and phase programming of long light pulses with narrow spectral bands using a modulator of short light pulses with wide spectral bands.

It more particularly concerns the adaptation of a programmable generator of ultra short wide spectral band light pulses, to long narrow spectral band light pulses.

In general, it is known that generators of ultra short wide spectral band laser pulses such as spatial programmable masks or filters (ex: liquid crystals) placed in the focal plane of a zero-dispersion optical delay line and programmable dispersive acousto-optic filters, generate pulses in the spectral domain by modifying, in a programmable way, the amplitude and phase of each frequency (or each wavelength) contained in the spectral band of the pulses. This allows generation over a time scale from a femtosecond to several picoseconds.

As for electro-optic temporal modulators, such as programmable Mach-Zehnder interferometers, realized in integrated optics, they allow one to generate, in time, only long pulses in the vicinity of several nanoseconds with a very narrow spectral band.

For intermediate programming times between approximately 10 picoseconds and 10 nanoseconds, there is no programmable laser pulse generation system, spectral systems not having a sufficient temporal programming excursion and temporal systems not having a sufficient programming bandwidth.

The object of the invention therefore more particularly aims to overcome this gap by proposing a device for adapting a programmable generator of ultra short wide spectral band light pulses, to long narrow spectral band light pulses, the duration of which is between 10 picoseconds and 10 nanoseconds.

The present invention consists of inserting a generator of wide spectral band light pulses between two nonlinear optical mixers, a linear dispersion device being placed upstream from the first mixer and the long, narrow spectral band light pulses, bearing the modulation, in amplitude and in phase, introduced by the aforementioned generator of large spectral band light pulses, being obtained at the outlet of the second nonlinear optical mixer.

To this end, the invention proposes a device to adapt a programmable generator of ultra short wide band spectral light pulses, to long narrow spectral band light pulses, comprising:
a laser source of ultra-short wide spectral band pulses,
a device for dispersion of ultra-short pulses output from said laser source,
a first non-linear optical mixer to mix long modulated pulses output from said dispersion device with long quasi-monochromatic signals output from a pure frequency pump laser,
a generator of wide spectral band light pulses placed on a first channel emerging from said first non-linear optical mixer at the frequency of said laser source of ultra-short pulses,
a second nonlinear optical mixer to mix the channel output from said generator and a second channel emerging from said first non-linear optical mixer at a frequency corresponding to the difference or the sum of the respective frequencies of the aforementioned pure frequency pump laser and the aforementioned laser source of short pulses.

Thus, the output signal of said second nonlinear optical mixer is a signal whereof the central frequency is equal to that of said pump laser; the duration of this output signal is equal to the duration of lengthening output from said dispersion device; the spectral band of this output signal is the resulting spectral band given by the spectral band of the aforementioned long pulses coming from the dispersion device modified by the ratio of the durations corresponding on one hand to the duration according to which one can modulate, in amplitude and in phase, a pulse using said generator, and on the other hand the lengthening duration output from said dispersion device.

As a result, this output signal, which is no longer modulated linearly in frequency on the spectral band of the pulses coming from the laser source of short pulses, bears, in the reduced spectral band, previously defined, the modulation, in amplitude and in phase, introduced by said generator of large band light pulses.

The frequency of said second channel emerging from the first nonlinear optical mixer corresponds to the difference or the sum of the frequencies, respectively from said pump laser at quasi-monochromatic frequency and from said laser source of short light pulses.

Indeed, when the frequency of said pump laser is greater than the frequency of the laser source of short pulses, the frequency of the second channel emerging from the first mixer corresponds to the difference in the frequencies of said pump laser at quasi-monochromatic frequency and from said laser source of short light pulses, respectively; in this case, the modulation slope of the long pulses has a sign opposite that of long pulses injected into the first mixer by the laser source of short pulses.

Reciprocally, the frequency of the second channel emerging from the first mixer corresponds to the sum of the frequencies of said pump laser at quasi-monochromatic frequency and from said laser source of short light pulses, respectively, if the frequency of said pump laser is less than the frequency of the laser source of short pulses; in this case, the modulation slope of the long pulses has the same sign as that of the long pulses injected into the first mixer by the laser source of short pulses.

Advantageously, said device for dispersing the ultra-short pulses coming from the laser source may be a dispersive optical fiber or a pair of parallel optical networks.

Advantageously, said generator of wide spectral band light pulses may be a spatial modulator of amplitude and phase placed in the focal plane of a zero dispersion optical delay line 4-f, or it may also be a programmable dispersive acousto-optic filter.

One embodiment of the invention will be described below, as a non-limiting example, in reference to the appended drawings in which:

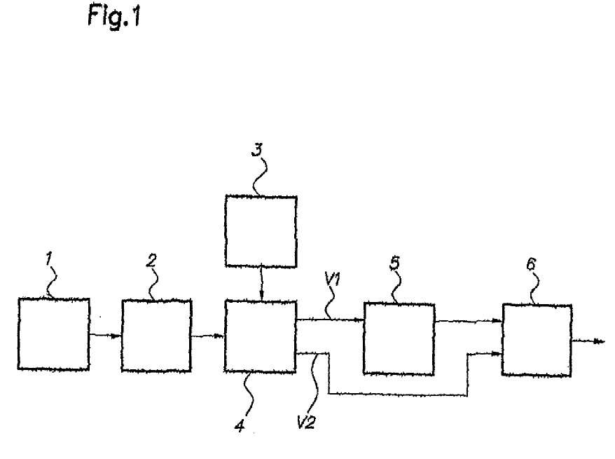

FIG. 1 is a diagrammatic illustration of the device according to a first version of the invention,

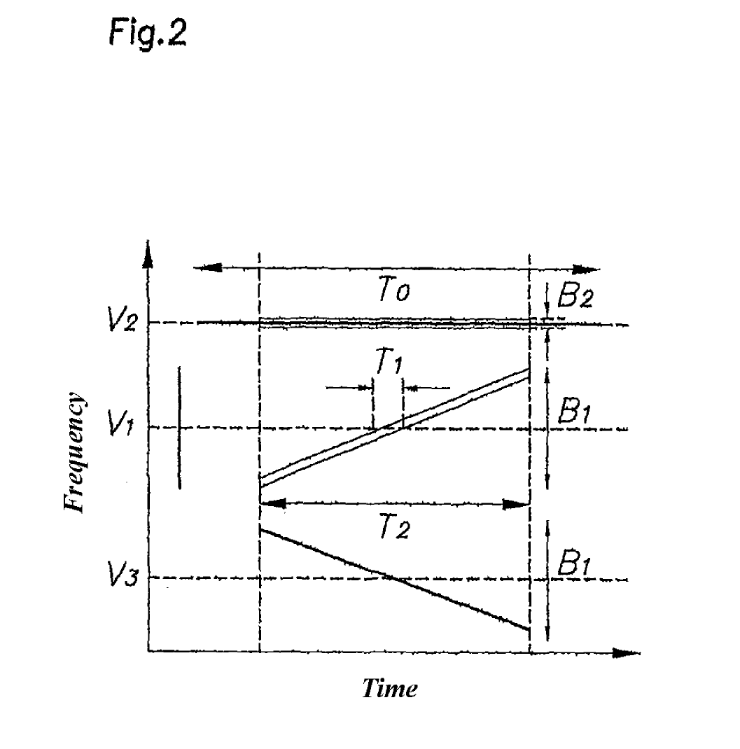

FIG. 2 is a time/frequency diagram corresponding to the first version of the invention,

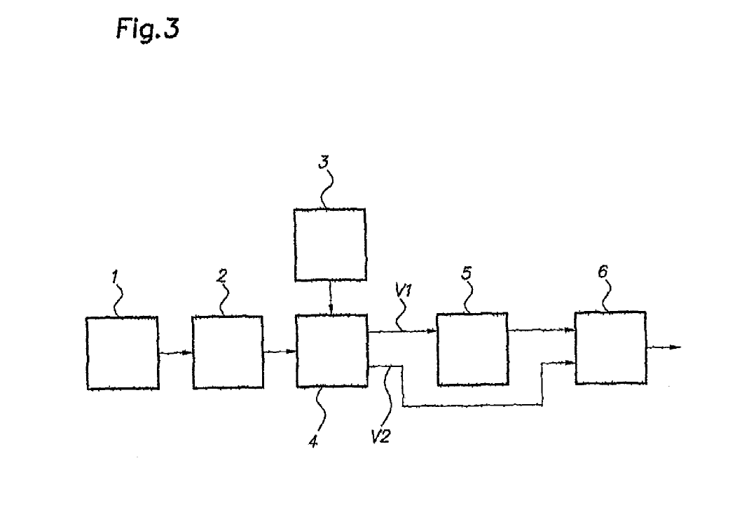

FIG. 3 is a diagrammatic illustration of the device according to a second version of the invention, and

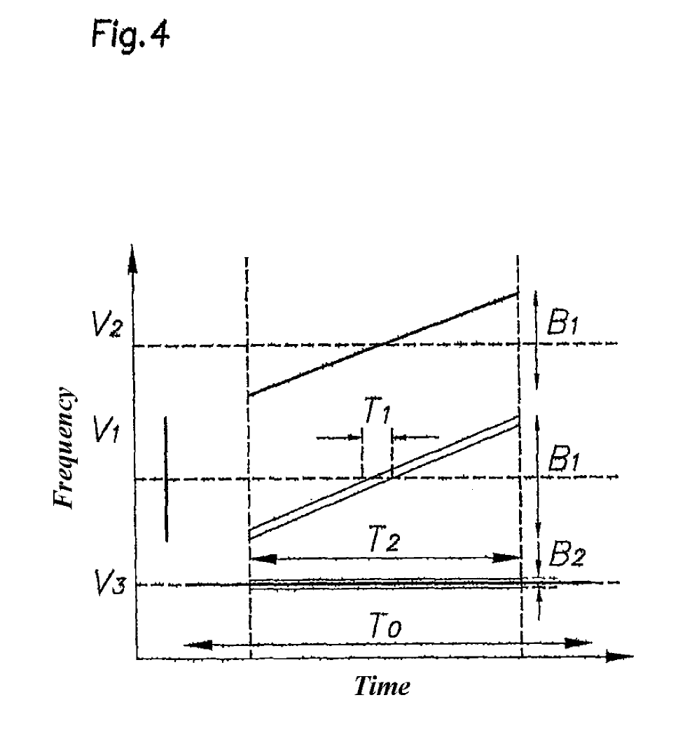

FIG. 4 is a time/frequency diagram corresponding to the second version of the invention.

In the example illustrated in FIG. 1:
a laser source 1 of ultra-short wide spectral band pulses delivers signals at the frequency v₁, spectral band B₁ and short duration of approximately 1/B₁,
downstream from said laser source 1, a dispersion device 2 for the ultra-short pulses coming from the laser source 1, this dispersion device 2 delivering signals at the frequency v₁, spectral band B₁ and duration T₂,
downstream from said dispersion device 2, a first nonlinear optical mixer 4, this mixer 4 mixing the long pulses coming from said dispersion device 2 with quasi-monochromatic long signals of duration T₀ greater than T₂ coming from a pure frequency v₂ pump laser 3, the pumping frequency v₂ being greater than the frequency v₁ of the laser source 1,
downstream from said first nonlinear optical mixer 4, a generator of wide spectral band light pulses 5 placed on a first channel V₁ of the signal emerging from said first nonlinear optical mixer 4 at the frequency v₁ of said laser source of ultra-short pulses 1,
downstream from said generator of wide spectral band light pulses 5, a second nonlinear optical mixer 6, this mixer 6 mixing the long pulses of frequency v₁ of duration T₂ coming from said generator of wide spectral band light pulses 5, and pulses emerging along the channel V₂ of said first optical mixer 4 of frequency v₃=v₂−v₁.

Thus, output from said second nonlinear optical mixer 6, the output signal is a signal of frequency v₂, spectral band B₂ and length T₂ which is no longer linearly modulated in frequency in the band B₁, but bears, in the band B₂, the modulation, in amplitude and in phase, introduced by the generator of wide band light pulses.

If T₁ is the time over which one can modulate, in amplitude and in phase, a light pulse of band B₁ using a generator of wide band pulses, the number of independent programming points is: N=B₁T₁.

The quantity of information, and therefore this number of points, being kept in the device illustrated in FIG. 1, the resulting modulation band B₂ is given by: B₂=B₁T₁/T₂.

This band is much narrower than B₁, since T₂ is in the vicinity of a nanosecond while T₁ is in the vicinity of a picosecond.

The modulation capacity of the generator of short wide band pulses was therefore transferred to long wide band signals.

In the example illustrated in FIG. 2, a time/frequency diagram corresponding to the first version of the invention diagrammatically indicates the spectral band of the light signals and their duration at the three previously stated frequencies, namely v₁, v₂, v₃, corresponding respectively to the light signals from the laser source 1, the laser source 3 and output from the first mixer 4 along the aforementioned channel V₂.

Thus, the ultra-short wide spectral band light pulses coming from the aforementioned laser source 1 have a frequency v₁, a wide spectral band B₁, and an ultra-short duration in the vicinity of 1/B₁.

The light pulses coming from said dispersion device have a frequency v₁, a wide spectral band B₁, a lengthened duration T₂ and an increasing (or decreasing) modulation slope of the frequency according to time.

The long quasi-monochromatic light pulses from said laser source 3 have a frequency v₂ greater than the frequency v₁ and a long duration T₀ greater than T₂.

The light pulses coming from said first optical mixer 4, along the channel V₂, have a frequency V₃, equal to v₂−v₁, a wide spectral band B₁, and a duration T₂.

At the output of said dispersion device, the modulation slope of the optical signal, coming from the laser 1, at the frequency v₁, spectral band B₁, duration T₂ being increasing (or decreasing), the modulation slope of the optical signal coming from the first optical mixer 4 along the channel V₂, at the frequency v₃, spectral band B₁, duration T₂, will be decreasing (or increasing)

In the example illustrated in FIG. 3:
a laser source 1 of ultra-short wide spectral band pulses delivers signals at the frequency v₁, spectral band B₁ and short duration of approximately 1/B₁,
downstream from said laser source 1, a dispersion device 2 of the ultra-short pulses coming from the laser source 1, this dispersion device 2 delivering signals at the frequency v₁, spectral band B₁ and duration T₂,
downstream from said dispersion device 2, a first nonlinear optical mixer 4, this mixer 4 mixing the long pulses coming from said dispersion device 2 with long quasi-monochromatic signals of duration T₀ greater than T₂ coming from a pump laser 3 at pure frequency v₂, the pumping frequency v₂ being less than the frequency v₁ of the laser source 1,
downstream from said first nonlinear optical mixer 4, a generator of wide spectral band light pulses 5 placed on a first channel V₁ of the signal emerging from said first nonlinear optical mixer 4 at the frequency v₁ of said laser source of ultra-short pulses 1,
downstream from said generator of wide spectral band light pulses 5, a second nonlinear optical mixer 6, this mixer 6 mixing the long pulses of frequency v₁, duration T₂ coming from said generator of wide spectral band light pulses 5, and the pulses emerging along the channel V₂ of said first optical mixer 4 of frequency v₃=v₂+v₁.

Thus, output from said second nonlinear optical mixer 6, the output signal is a signal of frequency v₂, spectral band B₂ and length T₂ which is no longer linearly modulated in frequency in the band B₁, but bears, in the band B₂, the modulation, in amplitude and in phase, introduced by the generator of wide band light pulses.

If T₁ is the time over which one can modulate, in amplitude and in phase, a light pulse with band B₁ using a generator of wide band pulses, the number of independent programming points is: N=B₁T₁.

The quantity of information, and therefore this number of points, being kept in the device illustrated in FIG. 1, the resulting modulation band B₂ is given by: B₂=B₁T₁/T₂.

This band is much narrower than B₁, since T₂ is in the vicinity of a nanosecond while T₁ is in the vicinity of a picosecond.

The modulation capacity of the generator of short wide band pulses was therefore transferred to long narrow band signals.

In the example illustrated in FIG. 4, a time/frequency diagram corresponding to the second version of the invention diagrammatically indicates the spectral band of the light signals and their duration at the three previously stated frequencies, namely v₁, v₂, v₃, corresponding respectively to the light signals of the laser source 1, the laser source 3 and output from the first mixer 4 along said channel V₂.

Thus, the ultra-short wide spectral band light pulses coming from said laser source 1 have a frequency v₁, a wide spectral band B₁, and an ultra-short duration in the vicinity of 1/B₁.

The light pulses coming from said dispersion device have a frequency v₁, a wide spectral band B₁, a lengthened duration T₂ and an increasing (or decreasing) modulation slope of frequency according to time.

The long quasi-monochromatic light pulses coming from said laser source 3 have a frequency v₂ less than the frequency v₁ and a long duration T₀ greater than T₂.

The light pulses coming from said first optical mixer 4, along the channel V₂, have a frequency v₃, equal to v₂+v₁, a wide spectral band B₁, and a duration T₂.

At the output of said dispersion device, the modulation slope of the optical signal, coming from the laser 1, at the frequency v₁, spectral band B₁, duration T₂ being increasing (or decreasing), the modulation slope of the optical signal coming from the first optical mixer 4 along the channel V₂, at the frequency v₃, spectral band B₁, duration T₂, will also be increasing (or decreasing).

Thus, the output signal of the second nonlinear optical mixer 6 is a signal whereof the central frequency v₂ is equivalent to that of the pump laser 3; the duration of this output signal is equal to the lengthening duration T₂ output from said dispersion device 2; the spectral band B₂ of this output signal is the resulting spectral band given by the spectral band B₁ of said long pulses coming form the dispersion device 2 modified by the ratio T₁/T₂ of the durations corresponding on one hand to the duration T₁ according to which one can modulate, in amplitude and in phase, a pulse using the generator 5, and on the other hand to the lengthening duration T₂ output from the dispersion device 2.

The modulation capacity of the generator 5 of short wide band pulses was therefore transferred to long narrow band signals.

1. A device for adapting a programmable generator of ultra-short wide spectral band light pulses to long narrow spectral band light pulses, said device comprising:
a laser source of ultra-short wide spectral band pulses,
a device for dispersion of ultra-short pulses output from said laser source,
a first nonlinear optical mixer to mix the long modulated pulses coming from said dispersion device with long quasi-monochromatic signals coming from a pure frequency pump laser,
a generator of wide spectral band light pulses placed on a first channel of the signal emerging from said first nonlinear optical mixer at the frequency of said laser source of ultra-short pulses,
a second nonlinear optical mixer to mix the channel output from said generator and a second channel emerging from said first nonlinear optical mixer at a frequency corresponding to the difference or the sum of the frequencies of said pure frequency pump laser and from said laser source of short pulses, respectively.

2. The device according to claim 1, wherein the frequency of said second channel emerging from said first optical mixer corresponds to the difference in the frequencies of said pure frequency pump laser and from said laser source of short light pulses, respectively, if the frequency of said pump laser is greater than the frequency of the laser source of short pulses.

3. The device according to claim 1, wherein the frequency of said second channel emerging from said first optical mixer corresponds to the sum of the frequencies of said pure frequency pump laser and of said laser source of short light pulses, respectively, if the frequency of said pump laser is less than the frequency of the laser source of short pulses.

4. The device according to claim 1, wherein said device for dispersion of ultra-short pulses output from the laser source is a dispersive optical fiber.

5. The device according to claim 1, wherein said device for dispersion of ultra-short pulses output from the laser source is a pair of optical networks.

6. The device according to claim 1, wherein said generator of wide spectral band light pulses is a spatial amplitude and phase modulator placed in the focal plane of a non-dispersive optical delay line called line 4-f.

7. The device according to claim 1, wherein said generator of wide spectral band light pulses is a programmable dispersive acousto-optical filter.
